(19) United States
(12) Patent Application Publication
(10) Pub. No.: US 2026/0350326 A1
(43) Pub. Date: Nov. 5, 2026

(54) RESPONSE CONTROL DEVICE, RESPONSE CONTROL METHOD, AND RESPONSE CONTROL PROGRAM

(71) Applicant: SONY GROUP CORPORATION, Tokyo (JP)

(72) Inventor: Yoshinori MAEDA, Tokyo (JP)

(21) Appl. No.: 19/484,130

(22) PCT Filed: May 14, 2024
(86) PCT No.: PCT/JP2024/017713

§ 371 Date: Nov. 13, 2025

(30) Foreign Application Priority Data
May 26, 2023 (JP) 2023-086839

(51) Int. Cl. G06F 40/58; G10L 25/63

(52) U.S. Cl. CPC G06F 40/58; G10L 25/63

(57) ABSTRACT

A response control device according to an aspect of the present disclosure includes an acquisition unit configured to acquire speech in a first language and character information being information indicating an individual personality of a speaker related to the speech; a response unit configured to generate a response to the speech in the first language by translating the speech in the first language into a second language and then generating a response sentence to the speech in the second language and translating the generated response sentence into the first language by using a translation model corresponding to the character information; and an output control unit configured to output the response generated by the response unit.

### TECHNICAL FIELD

The present disclosure relates to a response control device, a response control method, and a response control program for providing an interaction experience in which the personality of a character is reflected.

### BACKGROUND ART

Various techniques for presenting a three-dimensional virtual space constructed in a computer or a network to a user have been put into practical use. For example, the three-dimensional virtual space is constructed as a game space that operates on a computer or as a virtual world that imitates a real space called a metaverse or the like.

In these virtual spaces, virtual characters called non-player characters (NPC) may be arranged. The user can interact with the NPC in the virtual space using a character or an avatar operated by the user. For example, in the case of a game, the user can hear information related to gameplay from an NPC that is set with the content of a conversation in advance.

A dialogue model using artificial intelligence (AI) may be used in an interaction with an NPC. As a technique related to interaction, for example, a technique is known in which a meaning element is defined in a spoken sentence of a voice agent realized by AI, and the meaning element is replaced with a term according to character traits to express an interaction in line with a character.

### CITATION LIST

### Patent Literature

PTL 1:2022-29869

### SUMMARY

### Technical Problem

In the related art, an interaction can be realized in which character traits are expressed as if people having individual personalities are having an interaction with each other.

However, with a method of partially replacing a character string for each character trait, there is a possibility of causing entire sentences or expressions to be unnatural. In addition, it takes a lot of time and effort to prepare character strings to be replaced one by one in order to realize various personalities, which is not realistic. In this regard, a method of learning a dialogue model itself for generating a response sentence reflecting character traits is also conceivable, but there are problems such as the cost of a training environment for tuning a highly accurate dialogue model and the time required for training. Thus, such a method is difficult to realize.

Thus, the present disclosure is directed at a response control device, a response control method, and a response control program that are capable of providing an interaction experience in which the individual personality of a character is reflected with high accuracy without imposing an excessive preparation burden.

### Solution to Problem

To solve the problem described above, a response control device according to an aspect of the present disclosure comprises an acquisition unit configured to acquire speech in a first language and character information being information indicating an individual personality of a speaker related to the speech; a response unit configured to generate a response to the speech in the first language by translating the speech in the first language into a second language and then generating a response sentence to the speech in the second language and translating the generated response sentence into the first language by using a translation model corresponding to the character information; and an output control unit configured to output the response generated by the response unit.

### BRIEF DESCRIPTION OF DRAWINGS

FIG. 1 is a diagram (1) illustrating an overview of response control processing according to an embodiment.

FIG. 2 is a block diagram illustrating an overview of the response control processing according to the embodiment.

FIG. 3 is a diagram (2) illustrating an overview of the response control processing according to the embodiment.

FIG. 4 is a diagram illustrating an example of response sentence generation according to character information.

FIG. 5 is a diagram (1) illustrating an example of character information according to the embodiment.

FIG. 6 is a diagram (2) illustrating an example of character information according to the embodiment.

FIG. 7 is a diagram illustrating a configuration example of a response control device according to the embodiment.

FIG. 8 is a diagram illustrating an example of a character translation model storage unit according to the embodiment.

FIG. 9 is a flowchart illustrating a flow of the response control processing according to the embodiment.

FIG. 10 is a diagram illustrating an example of a character translation model storage unit according to a modification example.

FIG. 11 is a hardware configuration diagram illustrating an example of a computer for implementing the functions of the response control device.

### DESCRIPTION OF EMBODIMENTS

Hereinafter, embodiments will be described in detail with reference to the drawings. In the following embodiments, the same components are denoted by the same reference numerals, and redundant description thereof will be omitted.

The present disclosure will be described in the following item order.
1. Embodiment
   1-1. Overview of Response Control Processing According to Embodiment
   1-2. Configuration of Response Control Device according to Embodiment
   1-3. Procedure of Processing according to Embodiment)
   1-4. Modification Example
2. Other Embodiments
3. Effects of Response Control Device according to Present Disclosure
4. Hardware Configuration

### 1. Embodiment

### 1-1. Overview of Response Control Processing According to Embodiment

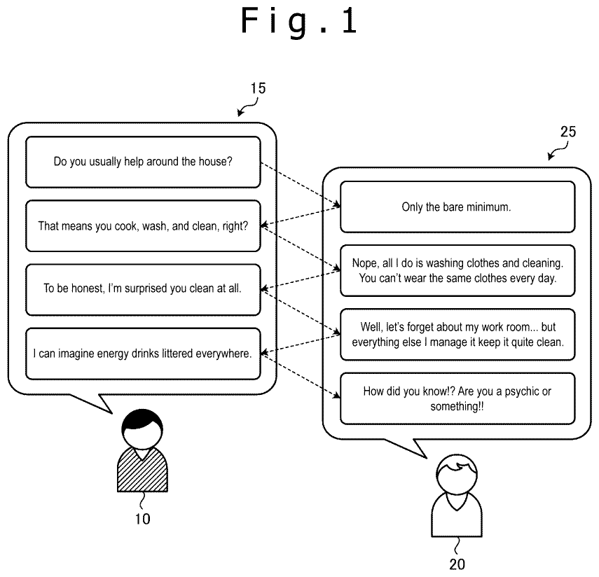

An example of the response control processing according to the embodiment will be described with reference to FIG. 1. FIG. 1 is a diagram (1) illustrating an overview of response control processing according to the embodiment.

The response control processing according to the embodiment is executed by a response control device 100 not illustrated in FIG. 1. The response control device 100 is an information processing terminal for executing content such as a game or implementing VR or AR technology. The response control device 100 is realized by any information processing device such as a game machine, a personal computer (PC), a tablet terminal, or a smartphone. The response control device 100 may be, for example, a head mounted display (HMD), AR glasses, or the like.

In the embodiment, the response control device 100 displays a three-dimensional virtual space (hereinafter, simply referred to as a “virtual space”) called a metaverse or the like and constructed in a computer or a network on a display unit (a display or the like).

The response control device 100 displays a character 10 that performs various behaviors in response to a user operation in the virtual space. The character 10 is a character that can be played by the user, and is referred to as a playable character, a player character, or the like. The response control device 100 displays, in the virtual space, a non-player character (NPC) 20 that is a character whose behavior is automatically performed by the game system.

For example, the response control device 100 reflects a gesture or a facial expression of the user on the character 10 in the virtual space based on an input by an input device such as a game controller, information obtained by imaging the user in the real space by an image sensor (a camera or the like), or the like. The response control device 100 reflects the speech of the character 10 in the virtual space by receiving text input via a controller, voice input via a microphone, or the like. This allows the user to experience a feeling as if the user themself exists in the virtual space.

A large number of NPCs are arranged in the virtual space. For example, the NPCs have roles including buying and selling game items that can be used by the user in the game and providing useful information in the game to the user. In addition, in order to virtually represent a town, a city, or the like, the NPCs are arranged in a manner imitating various roles, such as a company employee commuting to work, a shopper in a store, a general passerby, and a family with children. These NPCs are set to move, for example, to automatically wander in the virtual space, to go back and forth on a predetermined course, or to loop on a certain course.

By setting the personality, traits, and the like of each of these NPCs, the virtual space can be configured as a more realistic world. For example, in the NPC, a portion where character traits are expressed, such as individual expressions, word endings, and certain wording included in the speech of each character, can be effectively reflected to cause the user to feel a sense of reality. For example, as in the real world, the NPCs include a character that speaks friendly, a character that speaks politely, a character that speaks roughly, and the like. This enables the user to be further immersed in the world of the virtual space.

However, in a dialogue system that adapts to each one of a large number of NPCs existing in a virtual space, it is difficult to realize expressions in which a high-quality response sentence is matched with the tone of a character. For example, with a method of partially replacing a character string for each character trait, there is a possibility of causing entire sentences or expressions to be unnatural. In addition, a method of training a dialogue model itself for generating a response sentence reflecting a character trait also requires training of a large number of models to take into consideration the variety of personalities and is thus difficult to realize in terms of cost.

Thus, the response control device 100 according to the present disclosure solves the problem described above with the following configuration. First, the response control device 100 acquires speech in a first language and character information that is information indicating the individual personality of a speaker of the speech. Next, the response control device 100 translates the speech in the first language into a second language different from the first language. Further, the response control device 100 generates a response sentence to the speech by inputting the speech in the second language into a model that generates a response sentence. Thereafter, the response control device 100 translates the generated response sentence into the first language using a translation model corresponding to the character information to generate a response to the speech initially acquired. Finally, the response control device 100 outputs the generated response to the user by displaying the response on a screen or reproducing the response as audio.

That is, when generating the response sentence, the response control device 100 first extracts only the content of the response using the second language in which the expression of the individual personality and the like is excluded from the language. Then, the response control device 100 generates a response sentence to be finally output using a translation model trained with expressions of the extracted content in accordance with the individual personality. In this manner, the response control device 100 separately performs the processing of generating the content of the response itself and the processing of giving the individual personality to the content of the response. This makes it possible to generate a response in which the individual personality is reflected with high accuracy without training a model for generating a response sentence for each individual personality.

The response control processing will be described in order with reference to FIG. 1 and the subsequent drawings. For example, FIG. 1 illustrates a state in which the character 10 operated by a user and the NPC 20 are having an interaction in a virtual space that is one screen of game content. In the example of FIG. 1, it is assumed that the NPC 20 has a personality with a rather rough way of speaking.

In the example illustrated in FIG. 1, the contents of speech 15 of the character 10 and a response 25 of the NPC 20 are as follows.
Character 10: “Do you usually help around the house?”
NPC 20: “Only the bare minimum.”
Character 10: “That means you cook, wash, and clean, right?”
NPC 20: “Nope, all I do is washing clothes and cleaning. You can't wear the same clothes every day.”
Character 10: “To be honest, I'm surprised you clean at all.”
NPC 20: “Well, let's forget about my work room . . . but everything else I manage it keep it quite clean. ”
Character 10: “I can imagine energy drinks littered everywhere. ”
NPC 20: “How did you know!? Are you a psychic or something!!”

As described above, the response control device 100 reflects the words uttered by the user in the character 10 and outputs the speech of the NPC 20 that reacts to the words uttered by the character 10. In this manner, the response control device 100 outputs a natural response sentence reflecting the individual personality of the NPC 20 as if an actual person was interacting.

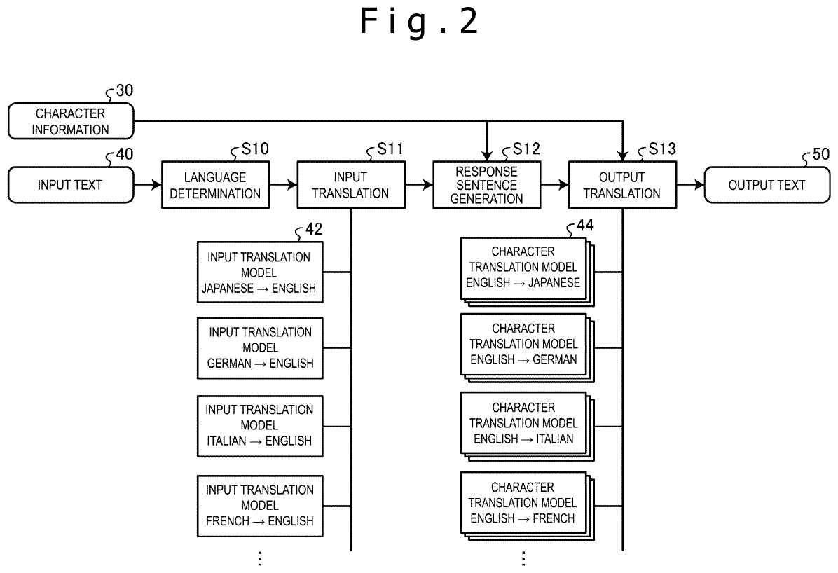

The response sentence generation processing illustrated in FIG. 1 will now be described with reference to FIG. 2. FIG. 2 is a block diagram illustrating an overview of the response control processing according to the embodiment.

The response control device 100 acquires audio uttered by the user or text input by the user as input text 40. The input text 40 corresponds to the speech of the character 10. The response control device 100 acquires character information 30 that is setting information related to the individual personality, such as personality and the like, of the NPC 20 that is the conversation partner of the user. The character information 30 may include not only the individual personality and the like set for the NPC 20 but also any information related to the NPC 20 such as a history of interaction with the character 10.

First, the response control device 100 performs language determination processing on the input text 40 (step S10). For example, the response control device 100 determines whether the input text 40 needs to be converted into a language that can be input to a response sentence generation model used in the dialogue system. In addition, when the input text 40 is not in a language that can be input to the response sentence generation model, the response control device 100 determines which language needs to be translated into which language. Note that, in the case of an interaction between NPCs that is not related to the user, the response control device 100 may determine that the conversion processing is not necessary because it is not necessary to output the language being processed.

Subsequently, the response control device 100 translates the input text 40 into a language used in the response sentence generation model using a translation model of a language corresponding to the acquired input text 40 (step S11). As an example, the response control device 100 selects an input translation model 42, which is a model for translating the content of the input text 40 in Japanese into English, and translates the input text 40. Note that a known model may be used as such a language translation model.

Subsequently, the response control device 100 generates a response sentence for the input text 40. For example, in the case of “Do you usually help around the house?” in Japanese as the speech of the character 10 illustrated in FIG. 1 for the input text 40, via translation of this speech into English, the response control device 100 generates “Only the bare minimum.” as the corresponding response sentence. That is, the response control device 100 first generates only the content of the response in the second language (English in this example) in which the individual personality is more difficult to be reflected in order to generate a response from which the individual personality and the like are excluded as a response to the input text 40. Note that a known model may be used as such a response sentence generation model. In addition, the response control device 100 acquires the character information 30 of the conversation partner and thus manages the interaction history with the NPC 20, which is necessary for interaction, at this stage. That is, the response control device 100 can read the interaction history associated with the NPC 20 by acquiring the character information 30 of the NPC 20 and can generate a response sentence with continuity with the interaction history.

Thereafter, the response control device 100 performs a translation for output so that the user can recognize the interaction with the NPC 20 (step S13). Here, the response control device 100 selects a translation model based on the character information 30 of the NPC 20. For example, the response control device 100 selects a character translation model 44 that is a model for translating from English to Japanese and that has been trained according to the individual personality of the NPC 20 who has a rough way of speaking.

That is, the response control device 100 translates the response sentence generated in step S12 into a form that matches the tone of the NPC 20 and into the same language as the language of the input text 40 initially input. Examples of the character translation model include various models such as a model according to a detailed set tone of each character, a model with only simple personality settings (“polite”, “rough”, and the like), and the like.

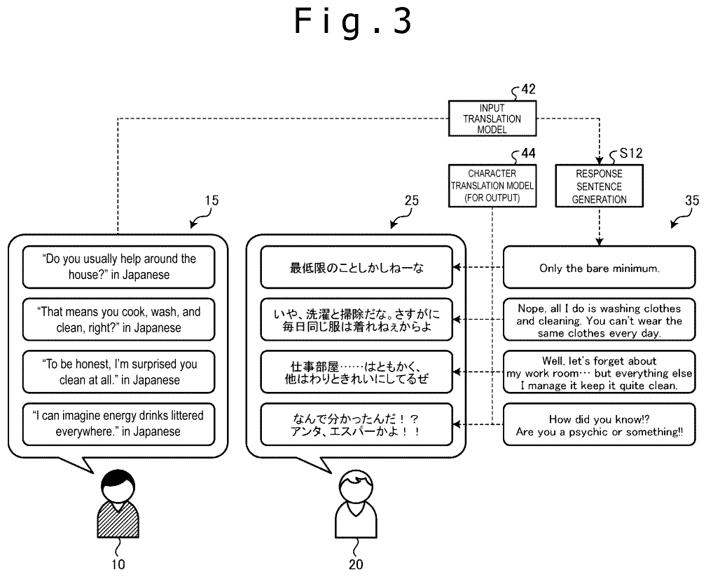

An example of the processing of FIG. 2 in combination with the interaction of FIG. 1 will now be described with reference to FIG. 3. FIG. 3 is a diagram (2) illustrating an overview of the response control processing according to the embodiment.

As illustrated in FIG. 3, the response control device 100 generates a response sentence uttered by the NPC 20 via the input translation model 42 each time speech 15 is input (step S12). Then, the response control device 100 outputs the response 25 of the NPC 20 to each of the generated response sentences using the character translation model 44. For example, the response control device 100 outputs the response 25 obtained by translating the response 35 in the second language (English) obtained in the generation of the response sentence using the character translation model 44 trained in accordance with the individual personality of the NPC 20.

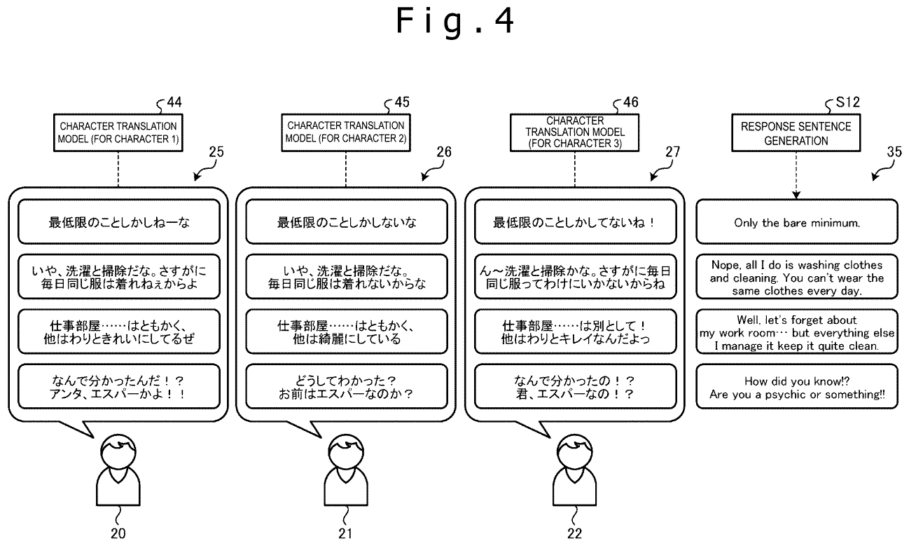

In this manner, the response control device 100 separately performs generation of a response sentence via the response sentence generation model and generation of an expression using the translation model that performs an expression in accordance with a character. Accordingly, the response control device 100 can generate responses of various tones for the NPCs from one common response sentence. This point will be described with reference to FIG. 4. FIG. 4 is a diagram illustrating an example of response sentence generation according to character information.

In the example of FIG. 4, an NPC 21 is a character set with a somewhat polite tone compared to the NPC 20. In this case, the response control device 100 translates a response 35 into the first language (Japanese in this example) via a character translation model 45 that has been trained in accordance with the tone (personality) corresponding to the NPC 21. Thus, the response control device 100 can output a response 26 for the NPC 21.

In another example of FIG. 4, an NPC 22 is a character that speaks in a somewhat friendly and child-like manner compared to the NPC 20. In this case, the response control device 100 translates the response 35 into the first language via a character translation model 46 that has been trained in accordance with the tone (personality) corresponding to the NPC 22. Thus, the response control device 100 can output a response 27 for the NPC 22.

Note that the NPCs arranged in the game have their own individual personality set for each other, and each of the NPCs can also have interactions independent of the user. In this case, the interaction between NPCs may be executed as internal processing when the interaction is not displayed on the screen or output by voice. When the interaction between NPCs is not output, the response control device 100 can omit translation from the first language to the second language and can execute the interaction only in terms of the content and without expression of individual personality.

As a specific example, take a case where an NPC 23 (not illustrated) who “has a serious personality and speaks in a friendly manner” and an NPC 24 (not illustrated) who “has a cold personality and speaks in a reserved manner” have an interaction.

The NPC 23 says to the NPC 24 “It's a nice day today, isn't it?”. The response control device 100 acquires “It's a nice day today, isn't it?” as the input text and converts the text into the second language (English in this example) in which character traits are not expressed. The response control device 100 generates a response to the translated speech. Such speech is internally processed as the following dialog.
NPC 23: “It's a nice day today, isn't it?”
NPC 24: “Well.”

If the speech of the NPC 24 is output in a form of screen display or the like, the response control device 100 performs conversion into a response sentence in line with the NPC 24 using language information of the original input text and character information. Since the NPC 24 has been given a reserved individual personality, the output of the character translation model is output in a form of a short reply after a moment of silence, for example, as follows.
NPC 23: “It's a nice day today, isn't it?”
NPC 24: “ . . . Yes.”

When it is not necessary to output the interaction between NPCs, the response control device 100 can perform processing more directly inside the system using the generated response sentence in the second language for the interaction processing. For example, the interaction between the NPC 23 and the NPC 24 is continued in the second language as follows.
NPC 23: “It's a nice day today, isn't it?”
NPC 24: “Well.”
NPC 23: “It's getting warmer and warmer, and spring may be around the corner.”
NPC 24: “That's true.”
NPC 23: “Are you okay with hay fever?” p1 NPC 24: “I don't have hay fever, so there's no problem.”
NPC 23: “I see. I envy you. It's pretty hard for me.”
NPC 24: “OK.”

When outputting the above-described dialogue, the response control device 100 may output the following dialogue using a character translation model based on each piece of character information.
NPC 23: “It's a nice day today, isn't it?”
NPC 24: “ . . . Yes.”
NPC 23: “It's getting warmer and warmer, and spring may be around the corner.”
NPC 24: “True . . . I guess.”
NPC 23: “Are you okay with hay fever?”
NPC 24: “I don't have hay fever, so there's no problem.”
NPC 23: “I see. I envy you. It's pretty hard for me.”
NPC 24: “OK . . . ”

Even if the contents of the above-described interaction are the same, the response control device 100 can output the following interaction in a case where the NPC 23 who “has a serious personality and speaks in a friendly manner” and an NPC 28 who “has a rough personality and speaks in a funny manner” have an interaction.
NPC 23: “It's a nice day today, isn't it?”
NPC 28: “It sure is.”
NPC 23: “It's getting warmer and warmer, and spring may be around the corner.”
NPC 28: “You ain't wrong about that.”
NPC 23: “Are you okay with hay fever?”
NPC 28: “Hay fever's never bothered me and I ain't never bothered bout it.”
NPC 23: “I see. I envy you. It's pretty hard for me.”
NPC 28: “That's tough.”

That is, even if the response sentences (English sentences) output from the response sentence generation model are the same, the response control device 100 can output an interaction with different expressions according to the character translation model selected thereafter.

When the user (character 10) is mixed in the interaction between the NPCs, the response control device 100 appropriately performs language determination and translation of the text input by the user. The response control device 100 generates a response sentence in accordance with an input of the user, translates the generated response sentence using the character translation model, and outputs a response. For example, the response control device 100 outputs the following interaction.
NPC 23: “It's a nice day today, isn't it?”
NPC 24: “ . . . Yes.”
NPC 23: “It's getting warmer and warmer, and spring may be around the corner.”
NPC 24: “True . . . I guess.”
NPC 23: “Are you okay with hay fever?”
NPC 24: “I don't have hay fever, so there's no problem.”
Character 10: “NPC 24 doesn't have hay fever? I envy you.” (Language determination and translation are performed on the input from the user)
NPC 23: “Me too. It's pretty hard for me.” (This response is generated in response to the user's speech)
NPC 24: “OK . . . ”

Note that since the user can participate in the interaction at any timing, the response control device 100 generates the response sentence of the NPC at the timing when the user participates in the interaction. Thus, it is assumed that the subsequent content of the above-described conversation changes depending on whether the user speaks to the NPC 23 or the NPC 24.

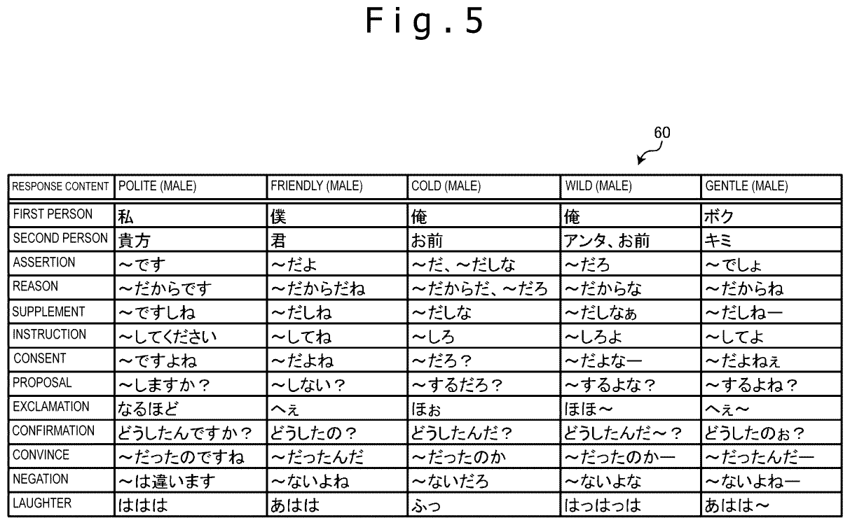

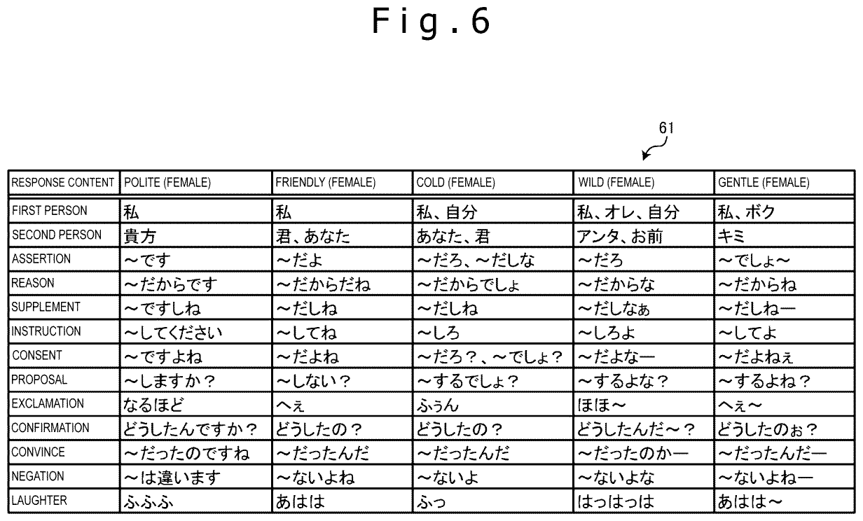

Here, a relationship between the character information set for the NPC and the translation result will be illustrated with reference to FIGS. 5 and 6. FIG. 5 is a diagram (1) illustrating an example of character information according to the embodiment. FIG. 6 is a diagram (2) illustrating an example of character information according to the embodiment.

A data table 60 in FIG. 5 illustrates output examples of a response sentence in a case where “male” is set as the gender of the NPC and the personality is set to each of “polite”, “friendly”, “cold”, “wild”, “gentle”, and the like.

Similarly, a data table 61 in FIG. 6 illustrates output examples of a response sentence in a case where “female” is set as the gender of the NPC and the personality is set to each of “polite”, “friendly”, “cold”, “wild”, “gentle”, and the like.

Note that when training the character translation model, the response control device 100 can generate a character translation model in line with each personality by collecting and learning text data (corpus) of expressions as illustrated in FIG. 5 or 6.

As described above with reference to FIGS. 1 to 6, according to the response control processing of the embodiment, the model for generating the response sentence excluding expression and the model for translating the response sentence into the language with the expression according to the individual personality are separately operated. In general, the interaction generation model needs to generate an accurate response based on semantic content and thus requires a large amount of training cost. On the other hand, the response control device 100 according to the embodiment separately performs generation of a response sentence via the response sentence generation model and generation of an expression using the translation model that performs an expression in accordance with a character. Accordingly, the response control device 100 can generate responses by NPCs of various tones without imposing a load that includes training a response sentence generation model for each character one by one. That is, the response control device 100 can output interaction expressions corresponding to various personalities with high accuracy without the time and effort involved in generating response sentence generation models corresponding to all personalities.

### 1-2. Configuration of Response Control Device according to Embodiment

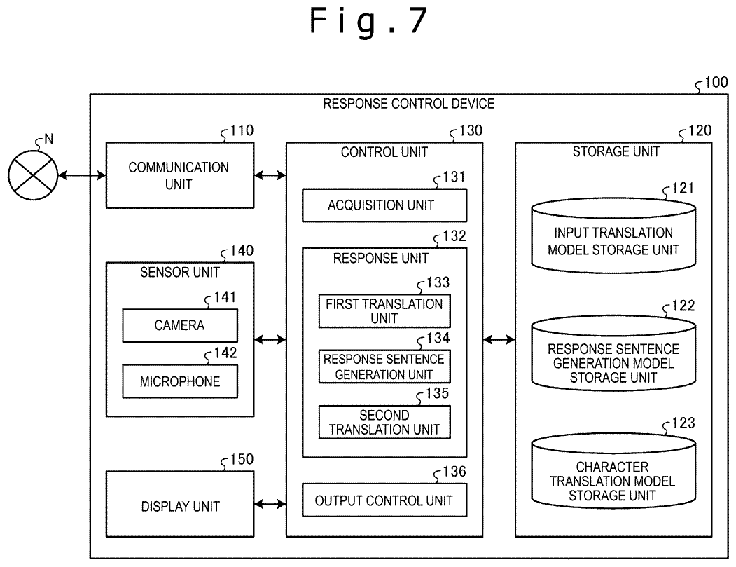

Next, the configuration of the response control device 100 will be described. FIG. 7 is a diagram illustrating a configuration example of the response control device 100 according to the embodiment.

As illustrated in FIG. 7, the response control device 100 includes a communication unit 110, a storage unit 120, a control unit 130, a sensor unit 140, and a display unit 150. The response control device 100 may include an input unit (a keyboard, a touch panel, or the like) that receives various operations from a user who operates the response control device 100.

The communication unit 110 is implemented by, for example, a network interface card (NIC), a network interface controller, or the like. The communication unit 110 is connected to a network N in a wired or wireless manner and transmits and receives information to and from an external device or the like via the network N. The network N is implemented by a wireless communication standard or method such as Bluetooth (trade name), the Internet, Wi-Fi (trade name), ultra wide band (UWB), or low power wide area (LPWA).

The storage unit 120 is implemented by, for example, a semiconductor memory element such as a random access memory (RAM) or a flash memory or a storage device such as a hard disk or an optical disk.

The storage unit 120 stores various types of information related to the response control processing according to the embodiment. In the embodiment, the storage unit 120 includes an input translation model storage unit 121, a response sentence generation model storage unit 122, and a character translation model storage unit 123.

The input translation model storage unit 121 stores a translation model for translating text in the first language input via audio or key input into a second language. For example, the input translation model storage unit 121 includes a model for translating text input in Japanese into text in English.

The response sentence generation model storage unit 122 stores a model used for generating a response sentence or an interaction.

The character translation model storage unit 123 stores a model for translating text in the second language into text including an expression reflecting the individual personality, such as gender, personality, and the like.

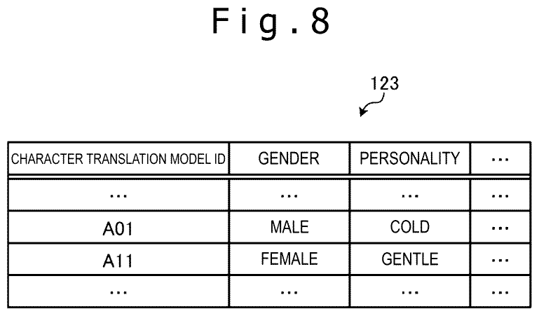

An example of a model held in the character translation model storage unit 123 will now be described with reference to FIG. 8. FIG. 8 is a diagram illustrating an example of the character translation model storage unit 123 according to the embodiment. As illustrated in FIG. 8, the character translation model storage unit 123 includes items such as “Character translation model ID”, “Gender”, and “Personality”.

“Character translation model ID” is identification information for identifying a character translation model. “Gender” indicates a gender set for the NPC that has interactions. “Personality” indicates a personality set to the NPC that has interactions. In other words, the character translation model storage unit 123 includes a different character translation model for each gender and personality of the NPC.

Referring back to FIG. 7, the description will be continued. The sensor unit 140 is a sensor that detects various types of environmental information. For example, the sensor unit 140 includes a camera 141 for sensing the appearance and behavior of the user, a microphone 142 for sensing audio input by the user, and the like.

The camera 141 recognizes, for example, a subject (for example, a user who is present in a real space) positioned in front of the response control device 100. The camera 141 may acquire an image of the user as a subject and calculate a distance from the camera 141 to the subject based on parallax between images captured by a stereo camera or analysis of captured image data. The sensor unit 140 may detect a distance in the real space using a depth sensor capable of detecting a distance to any subject such as the user.

The microphone 142 measures the voice of the user and ambient sound. For example, when performing voice chat, the user can perform audio input using the microphone 142 provided in the response control device 100.

In addition, for example, in a case where the response control device 100 is a wearable device such as an HMD, the sensor unit 140 may have a function of detecting various kinds of information related to the action of the user such as the direction, the inclination, the motion, and the moving speed of the body of the user in addition to the camera 141 and the microphone 142. Specifically, the sensor unit 140 detects, as the information related to the action of the user, information related to the head or orientation of the user, the motion (acceleration or angular velocity) of the head or body of the user, the direction of the field of view, the speed of the viewpoint movement, or the like. For example, the sensor unit 140 functions as various motion sensors such as a three axis acceleration sensor, a gyro sensor, and a speed sensor and detects information related to the action of the user. More specifically, the sensor unit 140 detects a change in at least one of the position and the orientation of the head of the user by detecting components in the yaw direction, the pitch direction, and the roll direction as the motion of the head of the user.

The sensor unit 140 does not necessarily need to be provided in the response control device 100 and may be, for example, an external sensor connected to the response control device 100 in a wired or wireless manner. For example, the camera 141 is not necessarily provided inside the response control device 100 and may be an imaging device installed outside the response control device 100.

The response control device 100 can reflect the behavior of the user detected by the sensor unit 140 in the virtual space. For example, the response control device 100 reflects the motion of the user raising their hand or the line of sight of the user on the character 10 and reflects the words uttered by the user as the speech of the character 10.

The display unit 150 displays various types of information output from the control unit 130. For example, the display unit 150 is a display that outputs a video to the user. The display unit 150 may include an audio output unit (such as a speaker) that outputs audio.

The control unit 130 is implemented by, for example, a central processing unit (CPU), a micro processing unit (MPU), a graphics processing unit (GPU), or the like executing a program (for example, a response control program according to the present disclosure) stored inside the response control device 100 using a RAM or the like as a work area. The control unit 130 is a controller and may be implemented by an integrated circuit such as an application specific integrated circuit (ASIC) or a field programmable gate array (FPGA).

As illustrated in FIG. 7, the control unit 130 includes an acquisition unit 131, a response unit 132, and an output control unit 136. The response unit 132 includes a first translation unit 133, a response sentence generation unit 134, and a second translation unit 135.

The acquisition unit 131 acquires various types of information. For example, the acquisition unit 131 acquires input information to be reflected in the character 10 by sensing the user using the sensor unit 140. Specifically, the acquisition unit 131 acquires the motion of the user in the real space or text included in audio as the input information.

The acquisition unit 131 acquires the character information set for each NPC. For example, the acquisition unit 131 recognizes an NPC with which the user is going to interact or an NPC displayed on the screen and acquires the character information of the recognized NPC. In addition, the acquisition unit 131 may acquire the interaction history between the user and the NPC as the character information in a case where the user and the NPC have had an interaction in the past or are currently having an interaction.

That is, the acquisition unit 131 acquires speech in the first language and character information that is information indicating the individual personality of a speaker (a speaker who has uttered speech or a conversation partner) related to the speech. The acquisition unit 131 passes the acquired information to the response unit 132.

The response unit 132 translates the speech in the first language into the second language and then generates a response sentence to the speech in the second language. The response unit 132 translates the generated response sentence into the first language using the character translation model corresponding to the character information to generate a response to the speech in the first language.

Specifically, the first translation unit 133 of the response unit 132 determines the input first language, selects the translation model corresponding to the determined first language, and translates the speech into the second language. In this manner, the response unit 132 acquires text that excludes character traits and includes only the semantic content of the speech. The response sentence generation unit 134 of the response unit 132 generates a response sentence in the second language for the text translated into the second language. At this time, the response sentence generation unit 134 may generate a response sentence to the speech in the second language with reference to the interaction history included in the character information. Subsequently, the second translation unit 135 of the response unit 132 translates the response sentence in the second language using a character translation model based on the character information of the NPC with which the user interacts to generate a response sentence in the first language in which the individual personality of the NPC is reflected.

As described above, the response unit 132 generates a response using a translation model that has been trained for each gender and personality set for a speaker. At this time, if it is determined that the response is not to be output in a format recognizable by the user, the response unit 132 may use the response sentence in the second language as the response without translating the response sentence into the first language.

For example, if it is determined that the user is not involved in the interaction, such as the case with interaction between NPCs in a game, the response unit 132 determines that it is not necessary to output the response in a format recognizable by the user, and the interaction in the second language can continue unchanged.

In the embodiment, the response unit 132 acquires speech in Japanese, which is the first language, and translates the speech in Japanese into English, which is the second language, to generate a response sentence, but the language is not limited to this example, and any languages may be used.

The output control unit 136 performs control to output the response generated by the response unit 132. For example, the output control unit 136 outputs the response by the NPC in any format such as by displaying the response sentence on the display unit 150 or reproducing audio corresponding to the response sentence from a speaker.

More specifically, the output control unit 136 outputs the response generated by the response unit 132 by text display in the first language or by audio in the first language. For example, the output control unit 136 outputs a response as a part (caption text display or the like) of an interaction between the user and an NPC in a virtual space in virtual space such as game content.

The output control unit 136 may control display of modes or the like of the NPCs in order to give a sense of reality to the virtual space. For example, the output control unit 136 displays a state in which NPCs are freely wandering in the virtual space or a state in which NPCs are naturally interacting with each other. Note that in a case where the user is caused to recognize the content of an interaction between NPCs, the output control unit 136 may display the interaction translated into the first language with the individual personality reflected even if the interaction is between NPCs. The output control unit 136 can express the virtual space as a world closer to reality via these display controls and thus can give a deep sense of immersion to the user.

### 1-3. Procedure of Processing According to Embodiment

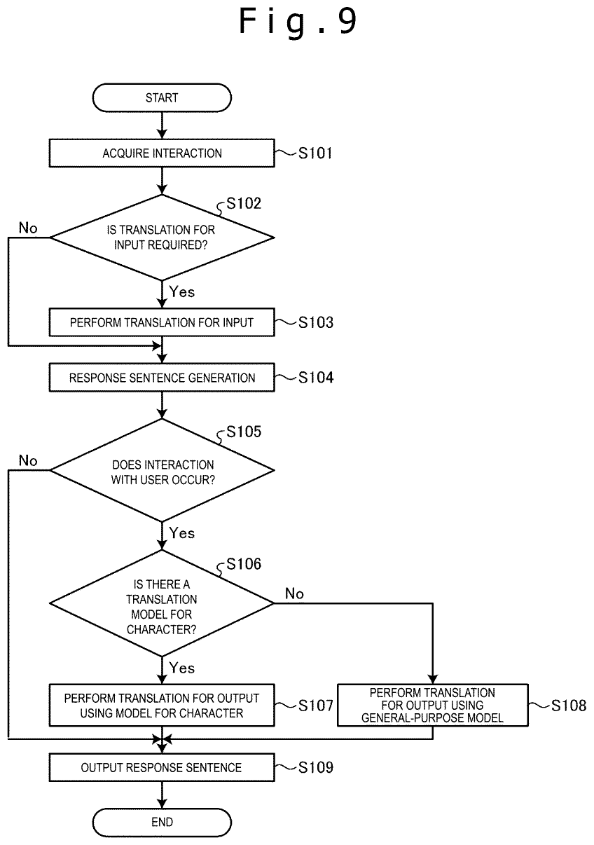

Next, a procedure of processing according to the embodiment will be described with reference to FIG. 9. FIG. 9 is a flowchart illustrating a flow of the response control processing according to the embodiment.

As illustrated in FIG. 9, the response control device 100 acquires an interaction (input text) (step S101). At this time, the response control device 100 may acquire the character information of the speaker related to the interaction.

The response control device 100 determines whether or not translation for input is necessary for the acquired interaction (step S102). In a case where translation for input is necessary (step S102; Yes), for example, when the acquired interaction is in the first language and translation into a language (second language) that can be input to the response sentence generation model is necessary, the response control device 100 executes translation for input (step S103).

Thereafter, the response control device 100 inputs the text of the translated word in the second language to the response sentence generation model to generate a response sentence (step S104). In a case where the translation for input is not necessary (step S102; No), the response control device 100 can directly input the acquired text to the response sentence generation model.

Subsequently, the response control device 100 determines whether or not an interaction with the user occurs in the interaction (step S105). In a case where a conversation with the user occurs (step S105; Yes), the response control device 100 needs to output a response in an expression in which the individual personality of the character is reflected, and thus refers to the character information of the NPC making a response, and then determines whether or not there is a translation model for the character corresponding to the character information (step S106).

In a case where there is a corresponding translation model for the character (step S106; Yes), the response control device 100 performs translating for output using the model for the character (step S107).

On the other hand, in a case where there is no corresponding translation model for the character (step S106; No), for example, when a model corresponding to the personality of the NPC is not prepared or when the NPC is set as a general-purpose character rather than an important character, the response control device 100 performs translating for output with a general-purpose model (step S108).

Thereafter, the response control device 100 outputs a response sentence for the NPC that is the interaction partner (step S109). Note that, in a case where no interaction with the user occurs (step S105; No) and the interaction between the NPCs continues, the response control device 100 may generate the response sentence in the second language as is because there is no need for translation.

### 1-4. Modification Example

The processing according to the embodiment described above may be accompanied by various modifications.

### 1-4-1. Response Including Emotion

In the embodiment described above, an example in which the response control device 100 generates a response sentence using a model for each personality of an NPC has been described. Here, the response control device 100 may further generate a response using a model trained according to the emotion of the NPC.

In other words, the response control device 100 can express a tone with emotion in the interaction of the NPC, similarly to the character setting.

In this case, the response control device 100 collects example sentences that match the emotion to be reflected in the interaction in order to train the character translation model including the emotion in advance. Specifically, the response control device 100 clusters a large number of collected example sentences and acquires the feature amount of the example sentence collection of a set that is considered to include the emotion. In this case, the feature amount is a representative value such as the average of values obtained by vectorizing the example sentences. The response control device 100 further collects example sentences including emotions by performing determination using the similarity with the vector information as a reference and trains a translation model using the collected data.

For example, when the emotion of the character changes during the progress of the interaction, the response control device 100 can generate a response that is more appropriate for the situation by applying the translation model including the trained emotion. That is, since the response control device 100 generates a response sentence using the interaction history, the response control device 100 can deduce a change in the emotion of the speaker due to the flow of the interaction using known emotion determination processing. In other words, the response control device 100 deduces an emotion (for example, “joy”, “anger”, “sadness”, “pleasure”, “confusion”, “fear”, or the like) to be applied to a response sentence generated next in the interaction. The response control device 100 applies a translation model corresponding to the deduced emotion.

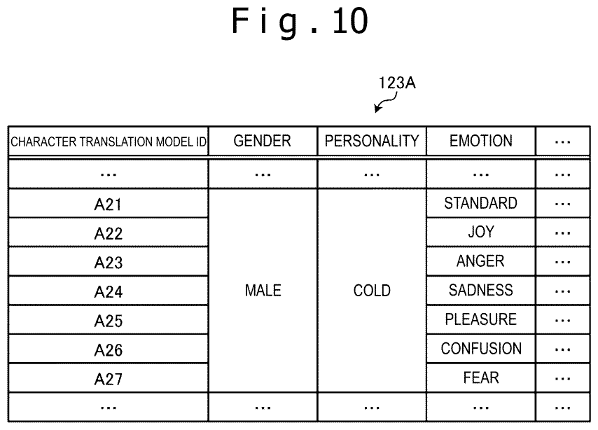

The translation model for each emotion is illustrated in FIG. 10. FIG. 10 is a diagram illustrating an example of a character translation model storage unit 123A according to a modification example. As illustrated in FIG. 10, the character translation model storage unit 123A includes an item such as “emotion” in addition to the character translation model storage unit 123.

The response control device 100 selects a model corresponding to the emotion deduced by the model for deducing the emotion based on the interaction content and translates the response sentence to output a response based on the emotion.

Take an example where an interaction with the following content is performed between a speaker A and a speaker B.
Speaker A: “Sorry, I can't go with you today.”
Speaker B: “Yeah, it's a short notice.”
Speaker A: “Something urgent came up.”
Speaker B: “I see, it can't be helped.”
Speaker A: “I'm really sorry.”
Speaker B: “Tell me early next time.”
Speaker A: “I'll make it up to you.”
Speaker B: “Yeah, maybe next time.”

In this case, the response control device 100 generates the following response in the second language based on the input text.
Speaker A: “Sorry, I can't go with you today.”
Speaker B: “Yeah, it's a short notice.”
Speaker A: “Something urgent came up.”
Speaker B: “I see, it can't be helped.”
Speaker A: “I'm really sorry.”
Speaker B: “Tell me early next time.”
Speaker A: “I'll make it up to you.”
Speaker B: “Yeah, maybe next time.”

At this time, when the speaker A is the NPC 23 described above who “has a serious personality and speaks in a friendly manner” and the speaker B is the NPC 24 described above who “has a cold personality and speaks in a reserved manner”, the response control device 100 can perform translation with expressions according to each character information. For example, the response control device 100 outputs the following interaction.
NPC 23: “Sorry, I know we had plans for tomorrow, but I can't go now.”
NPC 24: “Well that came out of nowhere.”
NPC 23: “Yeah something came up.”
NPC 24: “OK . . . ”
NPC 23: “I'm sorry.”
NPC 24: “Just tell us sooner next time.”
NPC 23: “I'll definitely make it up to you.”
NPC 24: “OK, . . . bye. ”

Here, the response control device 100 can perform the following output by applying a model according to the emotion of each interaction while performing the emotion deduction processing in the interaction. In this interaction, it is assumed that the NPC 24 has the emotion of “anger” during the interaction.
NPC 23: “Sorry, I know we had plans for tomorrow, but I can't go now.”
NPC 24: “Well that came out of nowhere.”
NPC 23: “Yeah something came up.”
NPC 24: “Whatever . . . ” (response including the emotion of “anger”)
NPC 23: “I'm sorry.”
NPC 24: “Next time you should say something sooner . . . ” (response including the emotion of “anger”)
NPC 23: “I'll definitely make it up to you.”
NPC 24: “You better . . . bye.” (response including the emotion of “anger”)

In another example indicated below, the speaker A is the NPC 23 who “has a serious personality and speaks in a friendly manner” and the speaker B is the NPC 28 who “has a rough personality and speaks in a funny manner”. When no emotion is included, the response control device 100 outputs the following interaction.
NPC 23: “Sorry, I know we had plans for tomorrow, but I can't go now.”
NPC 28: “What? Since when?”
NPC 23: “Yeah something came up.”
NPC 28: “Well OK, no harm done.”
NPC 23: “I'm sorry.”
NPC 28: “Just tell us sooner next time, alright.”
NPC 23: “I'll definitely make it up to you.”
NPC 28: “You got a deal, seeya!”

When the emotion deduction is applied to the above-described interaction, the response control device 100 outputs, for example, the following interaction.
NPC 23: “Sorry, I know we had plans for tomorrow, but I can't go now.”
NPC 28: “What? Since when?”
NPC 23: “Yeah something came up.”
NPC 28: “Seriously? Well whatever floats your boat.” (response including the emotion of “anger”)
NPC 23: “I'm sorry.”
NPC 28: “Next time you better be telling me sooner, OK.” (response including the emotion of “anger”)
NPC 23: “I'll definitely make it up to you.”
NPC 28: “Damnit, well seeya around.” (response including the emotion of “anger”)

Depending on the personality of the speaker, even if a response is generated using a model including an emotional expression, it may be difficult to distinguish between normal speech and speech including an emotion. In this case, the response control device 100 may perform not only text expression but also processing such as conversion of the intonation of a voice into one including a corresponding emotion.

The response control device 100 may forcibly set an emotion in an interaction instead of using a deduced emotion in an interaction. That is, the response control device 100 can include any emotion in the expression of the response by applying the translation model including the emotion instead of a normal translation model. The following is an example of an interaction that does not include an emotion.
NPC 23: “It's a nice day today, isn't it?”
NPC 24: “ . . . Yes.”
NPC 23: “It's getting warmer and warmer, and spring may be around the corner.”
NPC 24: “True . . . I guess.”
NPC 23: “Are you okay with hay fever?”
NPC 24: “I don't have hay fever, so there's no problem.”
NPC 23: “I see. I envy you. It's pretty hard for me.”
NPC 24: “OK . . . ”

The response control device 100 can output the following interaction by applying a model that has been trained to express emotions such as “joy” and “sadness” in the above-described interaction.
NPC 23: “It's a nice day today, isn't it?”
NPC 24: “ . . . Yes.”
NPC 23: “It's getting warmer and warmer, and spring may be around the corner.”
NPC 24: “True . . . I guess.”
NPC 23: “Are you okay with hay fever?”
NPC 24: “Me? Hay fever? Never had to worry about that in my life.” (example forcibly translated using a model corresponding to the emotion of “joy”)
NPC 23: “I see. I envy you. It's pretty hard for me.”
NPC 24: “Oh you poor thing . . . ” (example forcibly translated using a model corresponding to the emotion of “sadness”)

As another example, the response control device 100 can output the following interaction.
NPC 23: “It's a nice day today, isn't it?”
NPC 28: “It sure is.”
NPC 23: “It's getting warmer and warmer, and spring may be around the corner.”
NPC 28: “You ain't wrong about that.”
NPC 23: “Are you okay with hay fever?”
NPC 28: “Who has hay fever? Not me.” (example forcibly translated using a model corresponding to the emotion of “joy”)
NPC 23: “I see. I envy you. It's pretty hard for me.”
NPC 28: “Oh, ah, sorry.” (example forcibly translated using a model corresponding to the emotion of “sadness”)

In this manner, the response control device 100 can generate a response using a translation model that has been trained for each emotion set for a speaker. The response control device 100 may deduce the emotion of the speaker related to the speech and generate a response using a translation model corresponding to the deduced emotion, or may forcibly set the emotion of the speaker related to the speech and generate a response using a translation model corresponding to the set emotion. In this manner, the response control device 100 can provide the user with an interaction with a greater variety of expressions by outputting interactions including an emotion.

### 1-4-2. System Configuration

The configuration of the response control device 100 illustrated in FIG. 7 conceptually illustrates functions, and various aspects may be adopted depending on the embodiment. For example, in the embodiment described above, the response control device 100 performs the response control processing and the output control processing. However, the processing according to the embodiment may be executed by cooperation between a server device that performs the response control processing and an information processing terminal or the like that performs the output control processing. That is, the response control device 100 may be a device in which the display unit and the information processing unit are separately configured. In this case, the information processing unit of the response control device 100 may be any information processing device such as a server or a PC.

In the embodiment, an example in which the response control processing is executed in the virtual space has been described. However, the response control processing does not necessarily have to be executed in the virtual space. For example, the response control processing may be applied to an interaction between robots or smart speakers in a real space or may be applied to an interaction between a user and a robot or the like in a real space.

In the embodiment, an example is described in which, when the response control device 100 acquires speech in Japanese, which is the first language, the response control device 100 translates the speech into English, which is the second language, in order to make the speech into an expression excluding the individual personality. However, the translation is not limited to these languages. The response control device 100 may translate the first language into any abstract expression excluding the individual personality instead of translating the first language into the second language.

When generating a response sentence in the second language, the response control device 100 may generate the response sentence using a dialogue AI model or the like provided from an external service, instead of using the response sentence generation model stored in the storage unit 120.

### 2. Other Embodiments

The processing according to each of the above-described embodiments may be executed in various different modes other than the above-described embodiments.

In addition, among the processing operations described in the above-described embodiments, all or some of the processing operations described as being automatically performed may be manually performed, or all or some of the processing operations described as being manually performed may be automatically performed by a known method. In addition, the processing procedures, specific names, and information including various data and parameters described in the above-described document and drawings can be arbitrarily changed unless otherwise specified. For example, the various types of information illustrated in the drawings are not limited to the illustrated information.

The component elements of the devices illustrated in the drawings are functionally conceptual and are not necessarily physically configured as illustrated in the drawings. That is, specific modes of distribution and integration of the devices are not limited to those illustrated in the drawings, and all or some of the devices may be configured to be functionally or physically distributed or integrated in any unit amount according to various loads, usage conditions, and the like.

The embodiments and the modification examples described above can be combined as appropriate as long as the processing contents do not contradict each other.

In addition, the effects described in the present specification are merely examples and are not limited, and other effects may be obtained.

### 3. Effects of Response Control Device according to Present Disclosure

As described above, the response control device (the response control device 100 in the embodiment) according to the present disclosure includes the acquisition unit (the acquisition unit 131 in the embodiment), the response unit (the response unit 132 in the embodiment), and the output control unit (the output control unit 136 in the embodiment). The acquisition unit acquires speech in a first language and character information that is information indicating the individual personality of a speaker related to the speech. The response unit translates the speech in the first language into the second language, and then generates a response sentence in response to the speech in the second language and translates the generated response sentence into the first language using a translation model corresponding to the character information (a character translation model in the embodiment) to generate a response to the speech in the first language. The output control unit outputs the response generated by the response unit.

In this manner, the response control device according to the present disclosure performs generation of a response sentence related to the content of an interaction and processing of translating the generated response in a tone that matches the character using different models. Accordingly, the response control device can provide the user with an interaction experience in which the individual personality of the character is reflected with high accuracy without imposing an excessive preparation burden such as training of a large number of response generation models.

The response unit generates a response using a translation model trained for each gender or personality set for a speaker.

In this manner, the response control device can appropriately express the tone according to the character of the speaker by preparing models for each gender and personality as the models for translating the response sentence.

The response unit generates a response sentence to the speech in the second language with reference to the interaction history included in the character information.

Also, if it is determined by the output control unit that the response is not output in a format recognizable by the user, the response unit may use the response sentence in the second language as the response without translating the response sentence into the first language. Note that, in a case where it is determined that the user is not involved in the interaction related to the speech, the output control unit may determine that the response is not to be output in a format recognizable by the user.

In this manner, the response control device can reduce the load of the interaction process by internally processing the response that does not need to be output unchanged in the second language.

The response unit generates a response using a translation model trained for each emotion set for the speaker. For example, the response unit deduces the emotion of the speaker related to the speech and generates a response using a translation model corresponding to the deduced emotion. Alternatively, the response unit may set an emotion to the speaker related to the speech and generate a response using a translation model corresponding to the set emotion.

In this manner, the response control device can provide a user with a great variety of interaction expressions by expressing the tone including the emotion.

For example, the acquisition unit acquires speech in Japanese, which is the first language. The response unit translates the speech in Japanese into English, which is the second language. The output control unit outputs the response by text display in the first language or by audio in the first language. The output control unit may output the response as a part of an interaction between the user and an NPC in a virtual space.

In this manner, the response control device can provide the user with a virtual space experience with a sense of immersion including interaction with various expressions, by outputting the generated response as text or audio.

### 4. Hardware Configuration

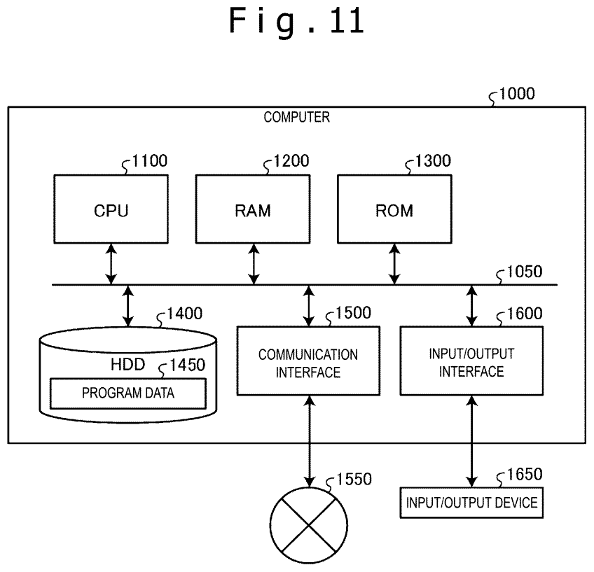

The information device such as the response control device 100 according to each of the above-described embodiments is implemented by a computer 1000 having a configuration illustrated in FIG. 11, for example. The response control device 100 will be described below using an example. FIG. 11 is a hardware configuration diagram illustrating an example of the computer 1000 for implementing the functions of the response control device 100. The computer 1000 includes a CPU 1100, a RAM 1200, a read only memory (ROM) 1300, a hard disk drive (HDD) 1400, a communication interface 1500, and an input/output interface 1600. The respective units of the computer 1000 are connected to each other via a bus 1050.

The CPU 1100 operates based on a program stored in the ROM 1300 or the HDD 1400 and controls each unit. For example, the CPU 1100 loads programs stored in the ROM 1300 or the HDD 1400 onto the RAM 1200 and executes processing operations corresponding to the various programs.

The ROM 1300 stores a boot program such as a basic input output system (BIOS) executed by the CPU 1100 at the time of activation of the computer 1000, a program depending on hardware of the computer 1000, and the like.

The HDD 1400 is a computer-readable storage medium that non-temporarily stores programs executed by the CPU 1100, data used by the programs, and the like. In particular, the HDD 1400 is a storage medium that stores a response control program according to the present disclosure, which is an example of program data 1450.

The communication interface 1500 is an interface for the computer 1000 to connect to an external network 1550 (for example, the Internet). For example, the CPU 1100 receives data from another device via the communication interface 1500 and transmits data generated by the CPU 1100 to another device via the communication interface 1500.

The input/output interface 1600 is an interface for connecting an input/output device 1650 and the computer 1000. For example, the CPU 1100 receives data from input devices such as a keyboard and a mouse via the input/output interface 1600. The CPU 1100 also sends data to an output device such as a display, speakers, printer, or the like via the input/output interface 1600. The input/output interface 1600 may function as a media interface that reads a program or the like stored in a predetermined storage medium (media). The medium is, for example, an optical storage medium such as a digital versatile disc (DVD) or a phase change rewritable disk (PD), a magneto-optical storage medium such as a magneto-optical disk (MO), a tape medium, a magnetic storage medium, a semiconductor memory, or the like.

For example, when the computer 1000 functions as the response control device 100 according to the embodiment, the CPU 1100 of the computer 1000 executes the response control program loaded onto the RAM 1200 to implement the functions of the control unit 130 and the like. The HDD 1400 stores the response control program according to the present disclosure and the data in the storage unit 120. Note that the CPU 1100 reads the program data 1450 from the HDD 1400 and executes it, but in another example, the CPU 1100 may acquire these programs from another device via the external network 1550.

Note that the present technique can also have the following configurations.
(1)
   A response control device comprising:
   an acquisition unit configured to acquire speech in a first language and character information being information indicating an individual personality of a speaker related to the speech;
   a response unit configured to generate a response to the speech in the first language by translating the speech in the first language into a second language and then generating a response sentence to the speech in the second language and translating the generated response sentence into the first language by using a translation model corresponding to the character information; and
   an output control unit configured to output the response generated by the response unit.
(2)
   The response control device according to (1) described above, wherein
   the response unit generates the response by using the translation model trained for each gender set for a speaker.
(3)
   The response control device according to (1) or (2) described above, wherein
   the response unit generates the response by using the translation model trained for each personality set for a speaker.
(4)
   The response control device according to any one of (1) to (3) described above, wherein
   the response unit references an interaction history included in the character information and generates a response sentence for the speech in the second language.
(5)
   The response control device according to any one of (1) to (4) described above, wherein
   in a case where it is determined by the output control unit that the response is not to be output in a format recognizable by a user, the response unit uses the response sentence in the second language as the response without translating the response sentence into the first language.
(6)
   The response control device according to (5) described above, wherein
   in a case where it is determined that the user is not involved in an interaction related to the speech, the output control unit determines that the response is not to be output in a format recognizable by the user.
(7)
   The response control device according to (3) described above, wherein
   the response unit generates the response by using the translation model trained for each emotion set for a speaker.
(8)
   The response control device according to (7) described above, wherein
   the response unit deduces an emotion of the speaker related to the speech and generates the response by using the translation model corresponding to the deduced emotion.
(9)
   The response control device according to (7) or (8) described above, wherein
   the response unit sets an emotion for the speaker related to the speech and generates the response by using the translation model corresponding to the set emotion.
(10)
   The response control device according to any one of (1) to (9) described above, wherein
   the acquisition unit acquires speech in Japanese, which is the first language, and
   the response unit translates the speech in Japanese into English, which is the second language.
(11)
   The response control device according to any one of (1) to (10) described above, wherein
   the output control unit outputs the response via a text display in the first language or via audio in the first language.
(12)
   The response control device according to (11) described above, wherein
   the output control unit outputs the response as a part of an interaction between a user and a non-player character (NPC) in a virtual space.
(13)
   A response control method comprising:
   by a computer,
   acquiring speech in a first language and character information being information indicating an individual personality of a speaker related to the speech,
   generating a response to the speech in the first language by translating the speech in the first language into a second language and then generating a response sentence to the speech in the second language and translating the generated response sentence into the first language by using a translation model corresponding to the character information, and
   outputting the generated response.
(14)
   A response control program that causes a computer to function as a response control device provided with:
   an acquisition unit configured to acquire speech in a first language and character information being information indicating an individual personality of a speaker related to the speech;
   a response unit configured to generate a response to the speech in the first language by translating the speech in the first language into a second language and then generating a response sentence to the speech in the second language and translating the generated response sentence into the first language by using a translation model corresponding to the character information; and an output control unit configured to output the response generated by the response unit.

### REFERENCE SIGNS LIST

10 Character
100 Response control device
110 Communication unit
120 Storage unit
121 Input translation model storage unit
122 Response sentence generation model storage unit
123 Character translation model storage unit
130 Control unit
131 Acquisition unit
132 Response unit
133 First translation unit
134 Response sentence generation unit
135 Second translation unit
136 Output control unit
140 Sensor unit
141 Camera
142 Microphone
150 Display unit

What is claimed is:

1. A response control device comprising:
an acquisition unit configured to acquire speech in a first language and character information being information indicating an individual personality of a speaker related to the speech;
a response unit configured to generate a response to the speech in the first language by translating the speech in the first language into a second language and then generating a response sentence to the speech in the second language and translating the generated response sentence into the first language by using a translation model corresponding to the character information; and
an output control unit configured to output the response generated by the response unit.

2. The response control device according to claim 1, wherein
the response unit generates the response by using the translation model trained for each gender set for a speaker.

3. The response control device according to claim 2, wherein
the response unit generates the response by using the translation model trained for each personality set for a speaker.

4. The response control device according to claim 1, wherein
the response unit references an interaction history included in the character information and generates a response sentence for the speech in the second language.

5. The response control device according to claim 1, wherein
in a case where it is determined by the output control unit that the response is not to be output in a format recognizable by a user, the response unit uses the response sentence in the second language as the response without translating the response sentence into the first language.

6. The response control device according to claim 5, wherein
in a case where it is determined that the user is not involved in an interaction related to the speech, the output control unit determines that the response is not to be output in a format recognizable by the user.

7. The response control device according to claim 3, wherein
the response unit generates the response by using the translation model trained for each emotion set for a speaker.

8. The response control device according to claim 7, wherein
the response unit deduces an emotion of the speaker related to the speech and generates the response by using the translation model corresponding to the deduced emotion.

9. The response control device according to claim 7, wherein
the response unit sets an emotion for the speaker related to the speech and generates the response by using the translation model corresponding to the set emotion.

10. The response control device according to claim 1, wherein
the acquisition unit acquires speech in Japanese, which is the first language, and
the response unit translates the speech in Japanese into English, which is the second language.

11. The response control device according to claim 1, wherein
the output control unit outputs the response via a text display in the first language or via audio in the first language.

12. The response control device according to claim 11, wherein
the output control unit outputs the response as a part of an interaction between a user and a non-player character (NPC) in a virtual space.

13. A response control method comprising:
by a computer,
acquiring speech in a first language and character information being information indicating an individual personality of a speaker related to the speech;
generating a response to the speech in the first language by translating the speech in the first language into a second language and then generating a response sentence to the speech in the second language and translating the generated response sentence into the first language by using a translation model corresponding to the character information; and
outputting the generated response.

14. A response control program that causes a computer to function as a response control device provided with:
an acquisition unit configured to acquire speech in a first language and character information being information indicating an individual personality of a speaker related to the speech;
a response unit configured to generate a response to the speech in the first language by translating the speech in the first language into a second language and then generating a response sentence to the speech in the second language and translating the generated response sentence into the first language by using a translation model corresponding to the character information; and
an output control unit configured to output the response generated by the response unit.
